(19) United States
(12) Patent Application Publication
(10) Pub. No.: US 2025/0034314 A1
(43) Pub. Date: Jan. 30, 2025

(54) POLYURETHANE COMPOSITION WITH STABLE MATT SURFACE AND GOOD CHALKING RESISTANCE

(71) Applicant: SIKA TECHNOLOGY AG, Baar (CH)

(72) Inventors: Junjie YANG, Suzhou (CN); Xiaoyan ZHANG, Suzhou (CN)

(73) Assignee: SIKA TECHNOLOGY AG, Baar (CH)

(21) Appl. No.: 18/716,583

(22) PCT Filed: Dec. 31, 2021
(86) PCT No.: PCT/CN2021/143552

§ 371 Date: Jun. 5, 2024

(51) Int. Cl. C08G 18/12; C08G 18/48; C08K 3/04; C08K 5/42

(52) U.S. Cl. CPC C08G 18/12; C08G 18/4812; C08G 18/4825; C08G 18/4829; C08K 3/04; C08K 5/42; C08G 2170/00; C08G 2190/00

(57) ABSTRACT

A polyurethane composition with stable matt surface and good chalking resistance, which is suitable for use as a sealant and/or an adhesive for sealing and/or bonding, preferably for gap-filling, particularly in construction and manufacturing industries. The polyurethane composition includes:—a polyurethane prepolymer containing an isocyanate group, including a MDI-based prepolymer synthesized from a polyether diol and a polyether triol with MDI, and a TDI-based prepolymer synthesized from a polyether diol and a polyether triol with TDI; and —a phenyl alkyl sulfonate in an amount of 12-25 wt %, preferably 18-25 wt %, based on the total weight of the composition.

### TECHNICAL FIELD

The present invention generally relates to a polyurethane composition, and particularly, to a polyurethane composition with stable matt surface and good chalking resistance, which is suitable for use as a sealant and/or an adhesive for sealing and/or bonding, preferably for gap-filling, particularly in construction and manufacturing industries.

### STATE OF THE ART

Curable polyurethane compositions, which is cross-linkable by reaction of isocyanate groups with hydroxyl and/or moisture or water, have found wide applications in industries, for example as sealants, adhesives or coatings, for sealing or bonding, particularly for gap-filling, in the construction and manufacturing industries, especially in the vehicle manufacturing and railway construction.

There are a variety of mature gap-filling products used in both bus and railway market. However, these products either contain solvent or are hard to be squeezed out, especially under low temperature. The increasing attention on environment protect in transportation industry triggers the solvent-free and low odor and low TVOC requirement for the gap-filling products.

Carbon black is commonly used in the polyurethane sealant and may be added in a higher amount to meet specific performance requirements. However, in a high carbon black content system, after replacing the solvent with a plasticizer, the sealant will become shiny easily. To solve this issue, the selection of plasticizer type is very crucial on top of improving the production process. In addition, carbon black tearing issue has troubled the bus manufactures for a long time, no existing technology was found that can totally solve the problem. To estimate carbon black tearing resistance, chalking resistance assessment was introduced. In other words, matt surface and good-chalking resistance is more and more concerned on gap-filling sealant in recent years, especially on the high carbon black content system.

CN109575869A discloses a one-component moisture-curing polyurethane sealant comprising a polyurethane prepolymer, a plasticizer, a carbon black, a catalyst, among others. The polyurethane prepolymer is made of polyether triol and MDI. The plasticizer includes phenyl alkyl sulfonates plasticizers, dinonyl phthalate, didecyl phthalate. CN109575869A states that a catalyst system consisting of organic bismuth and tertiary amine compounds is used to achieve smooth release of carbon dioxide and carbon black is used to adsorb carbon dioxide, thus avoiding blistering under high temperature and high humidity. However, it does not mention matt surface and chalking resistance.

Again, despite of a variety of existing gap-filling sealant, none of these can achieve good and stable matt surface and good chalking resistance at the same time, especially, none of these can pass 2000h UVA no chalking while maintaining other properties like existing gap-filling sealant.

### SUMMARY OF THE INVENTION

Therefore, an object of the present invention is to provide a new solvent-free polyurethane composition, which is suitable for use as a sealant or an adhesive, having good and stable matt surface and good chalking resistance, even in presence of high amount of carbon black, while maintaining other properties such as low odor, low TVOC, no blistering under high temperature and high humidity, as well as good application properties (such as low extrusion force, short cut-off string, good thixotropy), and good mechanical properties.

Surprisingly, this object has been solved by a polyurethane composition as defined in claim 1, which comprises specific polyurethane prepolymers and a phenyl alkyl sulfonate. Specifically, by introducing the phenyl alkyl sulfonate, matt surface issue of solvent-free gap-filling polyurethane sealant can be effectively solved while good application properties such as low extrusion, short cut-off string, and easy to be scratched, are maintained. In addition, by using the specific polyurethane prepolymers, i.e., a combination of a MDI-based prepolymer and a TDI-based prepolymer with a combination of diol and triol in each of the prepolymers, especially further by introducing a photocurable material such as an unsaturated acrylic compound, good chalking resistance can be achieved.

Further aspects of the invention are the subject of further independent claims. Particularly preferred embodiments of the invention are the subject of the dependent claims.

### Ways of Executing the Invention

In a first aspect, the present invention provides a polyurethane composition, characterized in that, it comprises:
a polyurethane prepolymer containing an isocyanate group, comprising:
   a MDI-based prepolymer synthesized from a polyether diol and a polyether triol with MDI, and
   a TDI-based prepolymer synthesized from a polyether diol and a polyether triol with TDI; and
a phenyl alkyl sulfonate in an amount of 12-25 wt %, preferably 18-25 wt %, based on the total weight of the composition.

In a second aspect, the present invention provides a method for improving matte surface and chalking resistance of a coating of a polyurethane composition, characterized in that, it comprises adding a phenyl alkyl sulfonate to a polyurethane composition comprising a polyurethane prepolymer containing an isocyanate group prior to curing, wherein,
the polyurethane prepolymer containing an isocyanate group comprises:
   a MDI-based prepolymer synthesized from a polyether diol and a polyether triol with MDI, and
   a TDI-based prepolymer synthesized from a polyether diol and a polyether triol with TDI; and
   the phenyl alkyl sulfonate is added in an amount of 12-25 wt %, preferably 18-25 wt %, based on the total weight of the composition.

In a third aspect, the present invention provides a use of the polyurethane composition as described above as a sealant and/or an adhesive for sealing and/or bonding, preferably for gap-filling, particularly in construction and manufacturing industries.

### Definitions

An “aromatic isocyanate” refers to an isocyanate wherein the isocyanate groups are bonded directly to an aromatic carbon atom. Accordingly, isocyanate groups of this kind are referred to as “aromatic isocyanate groups”.

An “aliphatic isocyanate” refers to an isocyanate wherein the isocyanate groups are bonded directly to an aliphatic carbon atom. Accordingly, isocyanate groups of this kind are referred to as “aliphatic isocyanate groups”.

Substance names beginning with “poly”, such as polyamine, polyol or polycyanate, refer to substances containing, in a formal sense, two or more of the functional groups that occur in their name per molecule.

Molecular weight of polymers is understood as the average molecular weight of their chain length distribution. “Average molecular weight” refers to the number-average molecular weight (Mn) of a polydisperse mixture of oligomeric or polymeric molecules or molecule residues. It is determined by means of gel permeation chromatography (GPC) against polystyrene as standard, especially with tetrahydrofuran as mobile phase, refractive index detector and evaluation from 200 g/mol.

“Room temperature” refers to a temperature of 23° C.

“Plasticizers” refer to liquid or dissolved substances which are not chemically incorporated within a cured polymer and typically exert a plasticizing effect on the polymer.

### Phenyl Alkyl Sulfonate

Plasticizers are commonly used in the polyurethane composition to improve viscosity, and thus the application properties of the composition. Conventional plasticizers used in the polyurethane composition include especially carboxylic acid esters, such as phthalates, especially diisononyl phthalate (DINP), diisodecyl phthalate (DIDP) or di(2-propylheptyl) phthalate (DPHP), hydrogenated phthalates, especially hydrogenated diisononyl phthalate or diisononyl cyclohexane-1,2-dicarboxylate (DINCH), terephthalates, especially dioctyl terephthalate, trimellitates, adipates, especially dioctyl adipate, azelates, sebacates, benzoates, glycol ethers, glycol esters, organic phosphoric or sulfonic acid esters, polybutenes, polybutenes or plasticizers derived from natural fats or oils, especially epoxidized soybean or linseed oil.

The phenyl alkyl sulfonate is also known as a plasticizer. It is environmentally friendly non-phthalate plasticizer with excellent plasticizing effect. It has excellent glue forming ability for most polymers including polyurethane. The present inventors have surprisingly found that, compared with other conventional plasticizers, especially phthalate plasticizers such as DIDP, DINP, dioctyl phthalate (DOP) and dibutyl phthalate (DBP), the phenyl alkyl sulfonate can achieve and maintain a good matt surface stability at similar viscosity level, even in the high carbon black content system. By the “high carbon black content” system, it means that the amount of carbon black in the polyurethane composition is greater than 9 wt %, preferably greater than 15 wt %, based on the total weight of the composition.

Preferably, the amount of the phenyl alkyl sulfonate in the polyurethane composition is 12-25 wt %, preferably 18-25 wt %, based on the total weight of the composition.

In a preferred embodiment of the invention, the polyurethane composition comprises predominantly the phenyl alkyl sulfonate as the plasticizer. By “predominantly”, it means that other plasticizers than the phenyl alkyl sulfonate, if any, present in an amount less than the phenyl alkyl sulfonate, preferably, less than 12 wt %, less than 5 wt %, or less than 1 wt %. Most preferably, the polyurethan composition does not comprise other plasticizers than the phenyl alkyl sulfonate.

### Polyurethane Prepolymer

A suitable polyurethane prepolymer containing isocyanate groups is especially obtained from the reaction of at least one polyol with a super stoichiometric amount of at least one isocyanate. The reaction is preferably conducted with exclusion of moisture at a temperature in the range from 50 to 160° C., optionally in the presence of suitable catalysts. The NCO/OH ratio is preferably in the range from 1.3/1 to 5/1, preferably 1.5/1 to 4/1, especially 1.8/1 to 3/1. The isocyanate remaining in the reaction mixture after the conversion of the OH groups, especially monomeric diisocyanate, can be removed, especially by means of distillation, which is preferable in the case of a high NCO/OH ratio. The polyurethane prepolymer obtained preferably has a content of free isocyanate groups in the range from 1% to 10% by weight, especially 1.5% to 6% by weight. The polyurethane prepolymer can optionally be prepared with additional use of plasticizers or solvents, in which case the plasticizers or solvents used do not contain any groups reactive toward isocyanates.

A suitable polycyanate is especially a commercially available polycyanate, especially
aromatic di- or triisocyanates, preferably diphenylmethane 4,4′- or 2,4′- or 2,2′-diisocyanate or any mixtures of these isomers (MDI), tolylene 2,4- or 2,6-diisocyanate or any mixtures of these isomers (TDI), mixtures of MDI and MDI homologs (polymeric MDI or PMDI), phenylene 1,3- or 1,4-diisocyanate, 2,3,5,6-tetramethyl-1,4-diisocyanatobenzene, naphthalene 1,5-diisocyanate (NDI), 3,3′-dimethyl-4,4′-diisocyanatodiphenyl (TODI), dianisidine diisocyanate (DADI), tris(4-isocyanatophenyl) methane or tris(4-isocyanatophenyl)thiophosphate; Preferably MDI or TDI;
aliphatic, cycloaliphatic or arylaliphatic di- or triisocyanates, preferably tetramethylene 1,4-diisocyanate, 2-methylpentamethylene 1,5-diisocyanate, hexamethylene 1,6-diisocyanate (HDI), 2,2,4- and/or 2,4,4-trimethylhexamethylene 1,6-diisocyanate (TMDI), decamethylene 1,10-diisocyanate, dodecamethylene 1,12-diisocyanate, lysine diisocyanate or lysine ester diisocyanate, cyclohexane 1,3- or 1,4-diisocyanate, 1-methyl-2,4- and/or2,6-diisocyanatocyclohexane (H6TDI), 1-isocyanato-3,3,5-trimethyl-5-isocyanatomethylcyclohexane (IPDI), perhydrodiphenylmethane 2,4′- and/or 4,4′-diisocyanate (H12MDI), 1,3- or 1,4-bis(isocyanatomethyl)cyclohexane, m- or p-xylylene diisocyanate, tetramethylxylylene 1,3- or 1,4-diisocyanate, 1,3,5-tris(isocyanatomethyl)benzene, bis(1-isocyanato-1-methylethyl) naphthalene, dimer or trimer fatty acid isocyanates, such as, especially, 3,6-bis(9-isocyanatononyl)-4,5-di(1-heptenyl)cyclohexene (dimeryl diisocyanate); preferably H12MDI or HDI or IPDI;
oligomers or derivatives of the di- or triisocyanates mentioned, especially derived from HDI, IPDI, MDI or TDI, especially oligomers containing uretdione or isocyanurate or iminooxadiazinedione groups or various groups among these; or di- or polyfunctional derivatives containing ester or urea or urethane or biuret or allophanate or carbodiimide or uretonimine or oxadiazinetrione groups or various groups among these. In practice, polycyanates of this kind are typically mixtures of substances having different degrees of oligomerization and/or chemical structures. They especially have an average NCO functionality of 2.1 to 4.0.

Preferred polycyanates are aliphatic, cycloaliphatic or aromatic diisocyanates, especially HDI, TMDI, cyclohexane 1,3- or 1,4-diisocyanate, IPDI, H12MDI, 1,3- or 1,4-bis(isocyanatomethyl)cyclohexane, XDI, TDI, MDI, phenylene 1,3- or 1,4-diisocyanate or naphthalene 1,5-diisocyanate (NDI).

A particularly preferred polycyanate is HDI, IPDI, H12MDI, TDI, MDI or a form of MDI which is liquid at room temperature, especially HDI, IPDI, TDI or MDI.

A form of MDI which is liquid at room temperature is either 4,4′-MDI liquefied by partial chemical modification—especially carbodiimidization or uretonimine formation or adduct formation with polyols—or it is a mixture of 4,4′-MDI with other MDI isomers (2,4′-MDI and/or 2,2′-MDI), and/or with MDI oligomers and/or MDI homologs (PMDI), that has been brought about selectively by blending or results from the production process.

Most preferred is IPDI, TDI or MDI.

Suitable polyols are commercial polyols or mixtures thereof, especially
polyether polyols, especially polyoxyalkylenediols and/or polyoxyalkylenetriols, especially polymerization products of ethylene oxide or 1,2-propylene oxide or 1,2- or 2,3-butylene oxide or oxetane or tetrahydrofuran or mixtures thereof, where these may be polymerized with the aid of a starter molecule having two or more active hydrogen atoms, especially a starter molecule such as water, ammonia or a compound having multiple OH or NH groups, such as, for example, ethane-1,2-diol, propane-1,2- or1,3-diol, neopentyl glycol, diethylene glycol, triethylene glycol, the isomeric dipropylene glycols or tripropylene glycols, the isomeric butanediols, pentanediols, hexanediols, heptanediols, octanediols, nonanediols, decanediols, undecanediols, cyclohexane-1,3- or1,4-dimethanol, bisphenol A, hydrogenated bisphenol A, 1,1,1-trimethylolethane, 1,1,1-trimethylolpropane, glycerol or aniline, or mixtures of the abovementioned compounds. Likewise suitable are polyether polyols with polymer particles dispersed therein, especially those with styrene/acrylonitrile (SAN) particles or polyurea or polyhydrazodicarbonamide (PHD) particles. Preferred polyether polyols are polyoxypropylene diols or polyoxypropylene triols, or what are called ethylene oxide-terminated (EO-endcapped) polyoxypropylene diols or triols. The latter are mixed polyoxyethylene/polyoxypropylene polyols which are especially obtained in that polyoxypropylene diols or triols, on conclusion of the polypropoxylation reaction, are further alkoxylated with ethylene oxide and thereby eventually have primary hydroxyl groups. Preferred polyether polyols have a degree of unsaturation of less than 0.02 meq/g, especially less than 0.01 meq/g.
Polyester polyols, also called oligoesterols, prepared by known processes, especially the polycondensation of hydroxycarboxylic acids or lactones or the polycondensation of aliphatic and/or aromatic polycarboxylic acids with di- or polyhydric alcohols. Preference is given to polyester diols from the reaction of dihydric alcohols, such as, especially, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the abovementioned alcohols, with organic dicarboxylic acids or the anhydrides or esters thereof, such as, especially, succinic acid, glutaric acid, adipic acid, suberic acid, sebacic acid, dodecanedicarboxylic acid, maleic acid, fumaric acid, phthalic acid, isophthalic acid, terephthalic acid or hexahydrophthalic acid or mixtures of the abovementioned acids, or polyester polyols from lactones, such as, especially, ¿-caprolactone. Particular preference is given to polyester polyols from adipic acid or sebacic acid or dodecanedicarboxylic acid and hexanediol or neopentyl glycol.
Polycarbonate polyols as obtainable by reaction, for example, of the abovementioned alcohols-used to form the polyester polyols—with dialkyl carbonates, diaryl carbonates or phosgene.
Block copolymers bearing at least two hydroxyl groups and having at least two different blocks having polyether, polyester and/or polycarbonate structure of the type described above, especially polyether polyester polyols.
Polyacrylate polyols and polymethacrylate polyols.
Polyhydroxy-functional fats and oils, for example natural fats and oils, especially castor oil; or polyols obtained by chemical modification of natural fats and oils-called oleochemical polyols—for example the epoxy polyesters or epoxy polyethers obtained by epoxidation of unsaturated oils and subsequent ring opening with carboxylic acids or alcohols, or polyols obtained by hydroformylation and hydrogenation of unsaturated oils; or polyols obtained from natural fats and oils by degradation processes, such as alcoholysis or ozonolysis, and subsequent chemical linkage, for example by transesterification or dimerization, of the degradation products or derivatives thereof thus obtained. Suitable degradation products of natural fats and oils are especially fatty acids and fatty alcohols and also fatty acid esters, especially the methyl esters (FAME), which can be derivatized to hydroxy fatty acid esters by hydroformylation and hydrogenation, for example.
Polyhydrocarbon polyols, also called oligohydrocarbonols, such as, for example, polyhydroxy-functional polyolefins, polybutylenes, polyprenes; polyhydroxy-functional ethylene/propylene, ethylene/butylene or ethylene/propylene/diene copolymers, as produced, for example, by Kraton Polymers; polyhydroxy-functional polymers of dienes, especially of 1,3-butadiene, which can especially also be prepared from anionic polymerization; polyhydroxy-functional copolymers of dienes, such as 1,3-butadiene, or diene mixtures and vinyl monomers, such as styrene, acrylonitrile, vinyl chloride, vinyl acetate, vinyl alcohol, isobutylene and isoprene, for example polyhydroxy-functional acrylonitrile/butadiene copolymers, as can be prepared, for example, from epoxides or aminoalcohols and carboxyl-terminated acrylonitrile/butadiene copolymers (commercially available, for example, under the Hypro® CTBN or CTBNX or ETBN name from Emerald Performance Materials); and hydrogenated polyhydroxy-functional polymers or copolymers of dienes.

Also especially suitable are mixtures of polyols.

Preference is given to polyether polyols, polyester polyols, polycarbonate polyols, poly(meth)acrylate polyols or polybutadiene polyols.

Particular preference is given to polyether polyols, polyester polyols, especially aliphatic polyester polyols, or polycarbonate polyols, especially aliphatic polycarbonate polyols.

The most preferred are polyether polyols, especially polyoxypropylene di- or triols or ethylene oxide-terminated polyoxypropylene di- or triols.

Preference is given to polyols having an average molecular weight in the range from 400 to 20 000 g/mol, preferably from 1000 to 10 000 g/mol.

Preference is given to polyols having an average OH functionality in the range from 1.6 to 3.

Preference is given to polyols that are liquid at room temperature.

Preference is given to polyols which are solid at room temperature for the preparation of a polyurethane prepolymer which is solid at room temperature.

In the preparation of a polyurethane prepolymer containing isocyanate groups, it is also possible to use fractions of di- or polyfunctional alcohols, especially 1,2-ethanediol, 1,2-propanediol, 1,3-propanediol, 2-methyl-1,3-propanediol, 1,2-butanediol, 1,3-butanediol, 1,4-butanediol, 1,3-pentanediol, 1,5-pentanediol, 3-methyl-1,5-pentanediol, neopentyl glycol, dibromoneopentyl glycol, 1,2-hexanediol, 1,6-hexanediol, 1,7-heptanediol, 1,2-octanediol, 1,8-octanediol, 2-ethyl-1,3-hexanediol, diethylene glycol, triethylene glycol, dipropylene glycol, tripropylene glycol, 1,3- or 1,4-cyclohexanedimethanol, ethoxylated bisphenol A, propoxylated bisphenol A, cyclohexanediol, hydrogenated bisphenol A, dimer fatty acid alcohols, 1,1,1-trimethylolethane, 1,1,1-trimethylolpropane, glycerol, pentaerythritol, sugar alcohols, such as especially xylitol, sorbitol or mannitol, or sugars, such as especially sucrose, or alkoxylated derivatives of the alcohols mentioned or mixtures of the alcohols mentioned.

Preference is given to the additional use of butane-1,4-diol for applications in which particularly high strengths are desired.

The polyurethane polymer containing isocyanate groups preferably has an average molecular weight in the range from 1′000 to 20′000 g/mol, especially 1′500 to 10′000 g/mol. It is preferably liquid at room temperature.

In a preferred embodiment of the invention, the polyurethane prepolymer containing an isocyanate group is a polymer of a polyether polyol with a diisocyanate, in particular a polyoxyalkylenediol and/or a polyoxyalkylenetriol with a diisocyanate such as TDI and/or MDI.

The present inventors have surprisingly found that, compared with a MDI-based prepolymer alone (i.e. only MDI is used as a diisocyanate in preparation of the prepolymer), and also compared with a triol-based prepolymer alone (i.e., only triol is used as a polyol in preparation of the prepolymer), a combination of the MDI-based prepolymer and the TDI-based prepolymer with a combination of diol and triol in each of the prepolymers, can significantly improve chalking resistance of the composition.

In a preferred embodiment of the invention, the polyurethane prepolymer containing an isocyanate group comprises a MDI-based prepolymer synthesized from a polyether diol and a polyether triol with MDI, and a TDI-based prepolymer synthesized from a polyether diol and a polyether triol with TDI.

In a preferred embodiment of the invention, an amount of the MDI-based prepolymer is 25-40 wt %, preferably 25-30 wt %, based on the total weight of the composition; and/or an amount of the TDI-based prepolymer is 5-10 wt %, preferably 5-8 wt %, based on the total weight of the composition.

In a preferred embodiment of the invention, the polyether diol is a polyoxyalkylene diol, preferably selected from a group consisting of a polyoxyethylene diol, a polyoxypropylene diol and a polyoxyethylene-polyoxypropylene diol, preferably from a group consisting of a polyoxypropylene diol and a polyoxyethylene-polyoxypropylene diol; and/or the polyether triol is a polyoxyalkylene triol, preferably selected from a group consisting of a polyoxyethylene triol, a polyoxypropylene triol and a polyoxyethylene-polyoxypropylene triol, preferably from a group consisting of a polyoxypropylene triol and a polyoxyethylene-polyoxypropylene triol.

In a preferred embodiment of the invention, a mole ratio of the polyether diol to the polyether triol in the polyurethane prepolymer is 1:1.1-1:2, preferably 1:1.1-1:1.5.

### Photocurable Material

Photocurable material readily suffers from a chemical change in its molecular structure by rays of light within a fairly short period of time, with a physical change such as curing. Such compounds include organic monomers, oligomers, resins, and other compositions containing them. Typically, they are unsaturated acrylic compounds, polyvinyl cinnamate and azide-containing compounds, as mentioned above.

Suitable unsaturated acrylic compounds include acrylic and methacrylic monomers having one or more unsaturated groups, their oligomers, and mixtures thereof. There are illustrated propylene (or butylene or ethylene)glycol di(meth)acrylate, neopentyl glycol di(meth)acrylate, tetramethylene dimethacrylate, as monomers and oligomers having not higher than 10,000 of molecular weight.

Polyvinyl cinnamate is a photosensitive resin having cinnamoyl group as the photosensitive group, and includes that prepared by esterifying polyvinyl alcohol with cinnamic acid, and many other polyvinyl cinnamate derivatives.

Azide-containing compounds have been known as photosensitive resins having azide group as the photosensitive group.

Such a photocurable material suffers from a chemical change in the molecular structure by rays of light within a fairly short period of time, with a physical change such a curing.

As for the photocurable materials selected from the group consisting of unsaturated acrylic compounds, polyvinyl cinnamate and azide-containing compounds, any of those commercially available may be suitably used.

The present inventors have surprisingly found that, based on the system than comprises a combination of a MDI-based prepolymer and a TDI-based prepolymer with a combination of diol and triol in each of the prepolymers, use of the photocurable material, especially the unsaturated acrylic compound, can significantly improve chalking resistance of the polyurethane composition. Preferably, the amount of the photocurable material, especially of the unsaturated acrylic compound in the polyurethane composition is 0.3-1 wt %, more preferably 0.4-0.8 wt %, based on the total weight of the composition.

### Photostabilizer

Photostabilizer can be used in the polyurethane composition to improve light resistance of the composition. The photostabilizer is preferably a hindered amine photostabilizer, including a UV stabilizer. As for resins which readily deteriorates by light, heat stabilizer and antioxidant may be combinedly used along with the photostabilizer, thereby their light resistance and weatherability being significantly improved.

Most of such hindered amine photostabilizers are commercially available, and include, for example, ADEKASTAB LA-52, LA-57, LA-62, LA-67, LA-63, LA-68, LA-77, LA-82 and LA-87 (manufactured by ASAHI DENKA KOGYO K. K.); bis(2,2,6,6-tetramethyl-4-piperidyl) sebacate, bis(1,2,2,6,6-pentamethyl-4-piperidyl) sebacate, 1-[2-(3,5-di-tert-butyl-4-hydroxyphenyl)-propionyloxy)ethyl]-4-[3-(3,5-di-tert-buty-4-hydroxyphenyl) propionyloxy]-2,2,6,6-tetramethylpiperidyl succinate, dimethyl-1-(2-hydroxyethyl)-4-hydroxy-2,2,6,6-tetramethylpiperidine polycondensate, poly[[6-1 (1,1,3,3-tetramethylbutyl)imino-1,3,5-triazin-2,4-diyl][(2,2,6,6-tetramethyl-4-piperdyl)imino]hexamethylene[(2,2,6,6-tetramethyl-4-piperdyl)imino]], bis(1,2,2,6,6-pentamethyl-4-piperidyl) 2-(3,5-di-t-butyl-4-hydroxybenzyl)-2-n-butyl malonate and the like.

In a preferred embodiment of the invention, the polyurethane composition comprises a photostabilizer, preferably in an amount of 0.05-0.2 wt %, more preferably 0.06-0.15 wt %, based on the total weight of the composition. Preferably, the photostabilizer is a hindered amine photostabilizer, preferably a UV stabilizer.

### Carbon Black

In a preferred embodiment of the invention, the polyurethane composition comprises carbon black, preferably in an amount greater than 9 wt %, preferably 12-18 wt %, based on the total weight of the composition. Incorporation of such high amount of carbon black can achieve low odor and low TVOC requirements while avoiding blistering in the sealant under high temperature and high humidity (e.g., 40° C. and 80%).

### Other Components

Preferably, the polyurethane composition comprises, in addition to the prepolymers, the phenyl alkyl sulfonate, the photocurable material, the photostabilizer and carbon black, additionally one or more further constituents that are especially selected from catalysts, fillers, auxiliaries and additives.

Suitable catalysts are especially catalysts for the hydrolysis of oxazolidino groups, especially organic acids, especially carboxylic acids, such as 2-ethylhexanoic acid, lauric acid, stearic acid, isostearic acid, oleic acid, neodecanoic acid, benzoic acid, salicylic acid or 2-nitrobenzoic acid, organic carboxylic acid anhydrides, such as phthalic anhydride, hexahydrophthalic anhydride or methylhexahydrophthalic anhydride, silyl esters of carboxylic acids, organic sulfonic acids, such as methanesulfonic acid, p-toluenesulfonic acid or 4-dodecylbenzenesulfonic acid, sulfonic acid esters, other organic or inorganic acids, or mixtures of the abovementioned acids and acid esters. Particular preference is given to carboxylic acids, especially aromatic carboxylic acids, such as benzoic acid, 2-nitrobenzoic acid or especially salicylic acid.

Suitable catalysts are furthermore catalysts for the acceleration of the reaction of isocyanate groups, especially organotin (IV) compounds, such as especially dibutyltin diacetate, dibutyltin dilaurate (DBTDL), dibutyltin dichloride, dibutyltin diacetylacetonate, dimethyltin dilaurate, dioctyltin diacetate, dioctyltin dilaurate or dioctyltin diacetylacetonate, complexes of bismuth (III) or zirconium (IV), especially with ligands selected from alkoxides, carboxylates, 1,3-diketonates, oxinate, 1,3-ketoesterates and 1,3-ketoamidates, or compounds containing tertiary amino groups, such as especially 2,2′-dimorpholinodiethyl ether (DMDEE).

Also especially suitable are combinations of different catalysts, such as a combination of DBTDL and DMDEE.

If used, the amount of the catalyst may be 0.01-0.5 wt %, preferably 0.06-0.2 wt %, based on the total weight of the composition

Suitable fillers are especially ground or precipitated calcium carbonates, optionally coated with fatty acids, especially stearates, barytes, quartz flours, quartz sands, dolomites, wollastonites, kaolins, calcined kaolins, sheet silicates, such as mica or talc, zeolites, aluminum hydroxides, magnesium hydroxides, silicas, including finely divided silicas from pyrolysis processes, cements, gypsums, fly ashes, industrially produced carbon blacks, graphite, metal powders, for example of aluminum, copper, iron, silver or steel, PVC powders or hollow beads. Especially suitable are calcium carbonates. If used, the amount of the filler may be 10-50 wt %, preferably 20-35 wt %, based on the total weight of the composition.

Suitable auxiliaries and additives may include:
inorganic or organic pigments, especially titanium dioxide, chromium oxides or iron oxides;
fibers, especially glass fibers, carbon fibers, metal fibers, ceramic fibers, polymer fibers, such as polyamide fibers or polyethylene fibers, or natural fibers, such as wool, cellulose, hemp or sisal;
dyes;
desiccants, especially molecular sieve powder, calcium oxide, highly reactive isocyanates, such as p-tosyl isocyanate (PTSI), monomeric diisocyanates or orthoformic esters; if used, the amount of the desiccant may be 0.3-1 wt %, preferably 0.4-0.8 wt %, based on the total weight of the composition;
adhesion promoters, especially organoalkoxysilanes, especially epoxysilanes, such as especially 3-glycidoxypropyltrimethoxysilane or 3-glycidoxypropyltriethoxysilane, (meth)acrylosilanes, anhydridosilanes, carbamatosilanes, alkylsilanes or iminosilanes, or oligomeric forms of these silanes, or titanates;
latent curing agents or crosslinkers, especially aldimines, ketimines, enamines or oxazolidines not conforming to the formula (I);
further catalysts which accelerate the reaction of the isocyanate groups, especially salts, soaps or complexes of tin, zinc, bismuth, iron, aluminum, molybdenum, dioxomolybdenum, titanium, zirconium or potassium, especially tin (II) 2-ethylhexanoate, tin (II) neodecanoate, zinc (II) acetate, zinc (II) 2-ethylhexanoate, zinc (II) laurate, zinc (II) acetylacetonate, aluminum lactate, aluminum oleate, diisopropoxytitanium bis(ethyl acetoacetate) or potassium acetate; compounds containing tertiary amino groups, especially N-ethyldiisopropylamine, N,N,N′,N′-tetramethylalkylenediamines, pentamethylalkylenetriamines and higher homologs thereof, bis(N,N-diethylaminoethyl) adipate, tris(3-dimethylaminopropyl)amine, 1,4-diazabicyclo[2.2.2]octane (DABCO), 1,8-diazabicyclo[5.4.0]undec-7-ene (DBU), 1,5-diazabicyclo[4.3.0]non-5-ene (DBN), N-alkylmorpholines, N,N′-dimethylpiperazine; aromatic nitrogen compounds, such as 4-dimethylaminopyridine, N-methylimidazole, N-vinylimidazole or 1,2-dimethylimidazole; organic ammonium compounds, such as benzyltrimethylammonium hydroxide or alkoxylated tertiary amines; what are called “delayed action” catalysts, which are modifications of known metal or amine catalysts;
rheology modifiers, especially thickeners, especially sheet silicates, such as bentonites, derivatives of castor oil, hydrogenated castor oil, polyamides, polyamide waxes, polyurethanes, urea compounds, fumed silicas, cellulose ethers or hydrophobically modified polyoxyethylenes;
natural resins, fats or oils, such as rosin, shellac, linseed oil, castor oil or soybean oil;
nonreactive polymers, especially homo- or copolymers of unsaturated monomers, especially from the group comprising ethylene, propylene, butylene, isobutylene, isoprene, vinyl acetate or alkyl(meth)acrylates, especially polyethylenes (PE), polypropylenes (PP), polybutylenes, ethylene/vinyl acetate copolymers (EVA) or atactic poly-α-olefins (APAO);
flame-retardant substances, especially the aluminum hydroxide or magnesium hydroxide fillers already mentioned, and also especially organic phosphoric acid esters, such as especially triethyl phosphate, tricresyl phosphate, triphenyl phosphate, diphenyl cresyl phosphate, isodecyl diphenyl phosphate, tris(1,3-dichloro-2-propyl)phosphate, tris(2-chloroethyl)phosphate, tris(2-ethylhexyl)phosphate, tris(chloroisopropyl)phosphate, tris(chloropropyl) phosphate, isopropylated triphenyl phosphate, mono-, bis- or tris(isopropylphenyl) phosphates of different degrees of isopropylation, resorcinol bis(diphenylphosphate), bisphenol A bis(diphenylphosphate) or ammonium polyphosphates;
additives, especially wetting agents, leveling agents, defoamers, deaerators, stabilizers against oxidation, heat, light or UV radiation, or biocides;
or further substances customarily used in moisture-curing compositions.

It may be advisable to chemically or physically dry certain substances before mixing them into the composition.

### Polyurethane Composition and Preparation Method Thereof

Advantageously, the polyurethane composition is a moisture-curable polyurethane composition, which is cross-linked and cured by reaction of isocyanate groups with hydroxyl and/or moisture or water.

The polyurethane composition is especially produced with exclusion of moisture and stored at ambient temperature in moisture-tight containers. A suitable moisture-tight container especially consists of an optionally coated metal and/or plastic, and is especially a drum, a transport box, a hobbock, a bucket, a canister, a can, a bag, a tubular bag, a cartridge or a tube.

Preferably, the composition is in the form of a one-component composition.

A composition referred to as a “one-component” composition is one in which all constituents of the composition are in the same container and which is storage-stable per se. Given suitable packaging and storage, it is storage-stable, typically over several months, up to one year or longer.

On application of the composition, the process of curing commences. This results in the cured composition.

In the case of a one-component composition, it is applied as such and then begins to cure under the influence of moisture or water. For acceleration of the curing, an accelerator component which contains or releases water and/or a catalyst can be mixed into the composition on application, or the composition, after application thereof, can be contacted with such an accelerator component.

The moisture required for the curing of the one-component composition preferably gets into the composition through diffusion from the air (atmospheric moisture). In the process, a solid layer of cured composition is formed on the surfaces of the composition which come into contact with air (“skin”). The curing continues in the direction of diffusion from the outside inward, the skin becoming increasingly thick and ultimately encompassing the entire composition applied. The moisture can also get into the composition additionally or entirely from one or more substrate(s) to which the composition has been applied and/or can come from an accelerator component which is mixed into the composition on application or is contacted therewith after application, for example by painting or spraying.

Any external moisture required to complete the curing of a two-component composition preferably comes from the air and/or from the substrates.

The composition is preferably applied at ambient temperature, especially in the range from about 0 to 50° C., preferably in the range from 5 to 40° C.

The composition is preferably likewise cured at ambient temperature.

### Applications

The polyurethane composition is preferably a sealant or an adhesive or a coating. The sealant or adhesive or coating is preferably elastic.

The polyurethane composition is especially suitable as a sealant and/or adhesive for sealing and bonding applications, particularly in gap-filling, especially in the construction and manufacturing industries, preferably in vehicle manufacturing and railway construction, especially for parquet bonding, installable component bonding, cavity sealing, assembly, module bonding, vehicle body bonding, window pane bonding or joint sealing.

Elastic bondings in motor vehicle construction are, for example, the bonded attachment of parts, such as plastic covers, trim strips, flanges, fenders, driver's cabins or other installable components, to the painted body of a motor vehicle, or the bonding of glass panes into the vehicle body, where the motor vehicles are especially automobiles, trucks, buses, rail vehicles or ships.

Therefore, the present invention further relates to an article obtained by sealing or bonding applications as described above.

### Advantageous Technical Effects

The polyurethane composition can bring about at least following advantageous technical effects:

1. The new polyurethane composition contains high amount of carbon black to achieve the low odor and low TVOC requirement while avoiding blistering in the sealant under high temperature and high humidity.

2. In this high carbon black system, the new plasticizer, the phenyl alkyl sulfonate can achieve and maintain a good matt surface stability compared with phthalate plasticizer at similar viscosity level.

3. The new polyurethane composition uses the combination of MDI-based and TDI-based prepolymers with the combination of diol and triol, based on this system, uses the unsaturated acrylic compound to significantly improve chalking resistance.

Consequently, the present invention provides a new solvent-free polyurethane composition, which is suitable for use as a sealant or an adhesive, having good and stable matt surface and good chalking resistance, even in presence of high amount of carbon black, while maintaining other properties such as low odor, low TVOC, no blistering under high temperature and high humidity, as well as good application properties (such as low extrusion force, short cut-off string, good thixotropy), and good mechanical properties.

### EXAMPLES

Working examples are adduced hereinafter, which are intended to further elucidate the invention described. Of course, the invention is not limited to these described working examples.

### Preparation of the Prepolymers

The polyols, isocyanates and catalyst used for preparation of the prepolymers are described below in Table 1.

TABLE 1
Description of polyols, isocyanates and catalyst for preparation
of prepolymers.

| Trade name | Description | Supplier |
|---|---|---|
| 330N | EO capped triol | Jiahua Chemical |
| | (Mw = 5000 g/mol) | |
| JH-240 | PO polymized diol | Jiahua Chemical |
| | (Mw = 4000 g/mol) | |
| GY-4000 | PO capped triol | Sanyo |
| | (Mw = 4000 g/mol) | |
| Desmodur T80 | TDI | Covestro |
| Desmodur 44C | MDI | Covestro |
| DBTDL | Catalyst | TCI |

Prepolymer P1 is a prepolymer comprising MDI and JH-240 (PO, Mw=4000) and GY-4000 (PO capped, Mw=4000), the NCO:OH was set at 2.24:1 (mole ratio), diol:triol=1:1.55 (mole ratio). Prepolymer P2 is a prepolymer comprising TDI and JH-240 (PO, Mw=4000) and GY-4000 (PO capped, Mw=4000), the NCO:OH was set at 1.77:1 (mole ratio), diol:triol=2.4:1 (mole ratio). Prepolymer P3 is a prepolymer comprising MDI and 330N (EO capped, Mw=5000), the NCO:OH was set at 2.1:1 (mole ratio).

For each prepolymer, the ingredients specified above were reacted in the ratio specified by a known method in Schrammoid (Aliva/234) with exclusion of moisture at a temperature of 80° C. in the presence of DBTDL to give an NCO-terminated polyurethane polymer.

### Preparation of the Polyurethane Compositions

For each composition, the ingredients specified in tables 2 were mixed in the amounts specified (in parts by weight) by means of Schrammoid (Aliva/234) with exclusion of moisture at a speed 250 rpm for a time and stored with exclusion of moisture.

### Test Methods

Each composition was tested as follows:

For determination of the extrusion force, the composition is dispensed into internally coated aluminum cartridge (outer diameter 46.9 mm, inner diameter 46.2 mm, length 215 mm, metric ISO thread M15×1.5 mm) and given an airtight seal with a polyethylene stopper (diameter 46.1 mm) from Novelis Germany GmbH. After conditioning at 23° C. for 24 hours, the cartridge weas opened and contents were extruded using an extrusion device. For this purpose, a nozzle with a 5 mm inside-diameter opening was screwed onto the cartridge thread. Using an extrusion device (Zwick/Roell Z005), a determination was made of the force needed to extrude the composition at an extrusion rate of 60 mm/min. The figure reported is an average value of the forces measured after an extrusion distance of 22 mm, 24 mm, 26 mm and 28 mm. After an extrusion distance of 30 mm, measurement was halted.

For determination of the skin time, several grams of the composition were taken with a LDFE pipette. The time until formation of a skin (“skin time”) is recorded.

The test method for the TVOC is conducted by referring to Test standard for Volatile Organics in Non-metallic Materials in Automobile Internal Decoration VDA 277.

To test the anti-sagging property, the composition was applied by an 8*10 mm adhesive nozzle on a vertical plane to form a triangle adhesive strip in a horizontal direction. After placing for 2 to 3 minutes, the sagging profile of the adhesive stripe tip was observed. The standard for determining sagging property was as follows:
1—tip having no move;
2—tip sagging to the middle of the initial triangle apex and the perpendicular line of lower apex angle;
3—tip sagging to the height of the perpendicular line of triangle's lower apex angle;
4—tip sagging to below the perpendicular line of lower apex angle;
5—no tip.

For the gloss test, the composition is applied in a mold with the dimension of 6*100*60 mm, the composition is scratched to make the surface smooth and flush with the mold edge. After curing for 7 days at RT, test the gloss of the surface with a gloss meter.

For evaluation of the chalking resistance, the cured composition was conditioned in QUV for 2000 hours. The test tape for every specimen should be the same and has to be transparent. The tape is pressed on the conditioned specimen with a spatula and rubbed over this surface approx. 10 times (Ensure that air enclosures/air bubbles are pressed out of tested area). The tape is removed slowly in approx. 2 seconds in an angle of approx. 135°, the tape is sticked/pressed on photo-cardboard, results (tape on cardboard) are evaluated immediately with the rating 0 to 4. Evaluation is based on DIN EN ISO 4628-6 adapted for adhesives/sealants.

The formulations of the polyurethane compositions and test results thereof are shown below in Table 2.

TABLE 2
Formulations of polyurethane compositions and test results thereof.

| Composition | Supplier | Trade name | E1 | E2 | E3 | E4 |
|---|---|---|---|---|---|---|
| prepolymer P1 | Sika internal | / | 28 | 28 | 35 | |
| MDI + diol + triol | | | | | | |
| prepolymer P2 | Sika internal | / | 7 | 7 | | |
| TDI + diol + triol | | | | | | |
| prepolymer P3 | Sika internal | / | | | | 35 |
| MDI + triol | | | | | | |
| phenyl alkyl sulfonate | LANXESS | Mesamoll | 23.5 | | 23.5 | 23.5 |
| DIDP | Exxon Mobil | Jayflex DIDP | | 20.5 | | |
| Cabot M570 | Cabot | Monarch 570 | 17 | 17 | 17 | 17 |
| UV additive | Adeka | ADK LA-63P | 0.06 | 0.06 | 0.06 | 0.06 |
| Aronix M8060 | TOAGOSEI | ARONIX | 0.5 | 0.5 | 0.5 | 0.5 |
| | CO., LTD. | M-8060 | | | | |
| CaCO₃ | Omya | Omyacarb | 23.37 | 26.37 | 23.37 | 23.37 |
| | | 5GU | | | | |
| PTSI | Pingyuan Xinda | TI | 0.44 | 0.44 | 0.44 | 0.44 |
| | Chemical | | | | | |
| DBTDL | TCI | DBTDL | 0.03 | 0.03 | 0.03 | 0.03 |
| DMDEE | Huntsman | Jeffcat | 0.1 | 0.1 | 0.1 | 0.1 |
| | | DMDEE | | | | |
| total | | | 100 | 100 | 100 | 100 |
| extrusion force using | | | 700 | 720 | 830 | 890 |
| 3 mm nozzle (N) | | | | | | |
| skin time (min) | | | 45 | 47 | 38 | 28 |
| gloss at 60° after | | | 14 | 22 | 17 | 26 |
| 1 d RT | | | | | | |
| gloss at 60° after | | | 16 | 40 | 35 | 44 |
| 7 d 60° C. | | | | | | |
| non-sag after 1 d RT | | | 1 | 1 | 1 | 1 |
| non-sag after 7 d | | | 1 | 2 | 1 | 1 |
| 60° C. | | | | | | |
| TVOC (μgC/g) | | | 15 | 13 | 15 | 16 |
| chalking resistance | | | 1 | 4 | 4 | 4 |
| after 2000 h UVA | | | | | | |
| chalking resistance | | | 1 | 4 | 4 | 4 |
| after 2000 h UVB | | | | | | |

| Composition | Supplier | Trade name | E1 | E5 | E6 | E7 | E8 |
|---|---|---|---|---|---|---|---|
| prepolymer P1 | Sika internal | / | 28 | 28 | 28 | 28 | 28 |
| MDI + diol + triol | | | | | | | |
| prepolymer P2 | Sika internal | / | 7 | 7 | 7 | 7 | 7 |
| TDI + diol + triol | | | | | | | |
| prepolymer P3 | Sika internal | / | | | | | |
| MDI + triol | | | | | | | |
| phenyl alkyl sulfonate | LANXESS | Mesamoll | 23.5 | 23.5 | 23.5 | 27 | 10 |
| DIDP | Exxon Mobil | Jayflex DIDP | | | | | 10.5 |
| Cabot M570 | Cabot | Monarch 570 | 17 | 17 | 17 | 17 | 17 |
| UV additive | Adeka | ADK LA-63P | 0.06 | 0.06 | 0.06 | 0.06 | 0.06 |
| Aronix M8060 | TOAGOSEI | ARONIX | 0.5 | 1.2 | 0.2 | 0.5 | 0.5 |
| | CO., LTD. | M-8060 | | | | | |
| CaCO₃ | Omya | Omyacarb | 23.37 | 22.67 | 23.67 | 19.87 | 26.37 |
| | | 5GU | | | | | |
| PTSI | Pingyuan Xinda | TI | 0.44 | 0.44 | 0.44 | 0.44 | 0.44 |
| | Chemical | | | | | | |
| DBTDL | TCI | DBTDL | 0.03 | 0.03 | 0.03 | 0.03 | 0.03 |
| DMDEE | Huntsman | Jeffcat | 0.1 | 0.1 | 0.1 | 0.1 | 0.1 |
| | | DMDEE | | | | | |
| total | | | 100 | 100 | 100 | 100 | 100 |
| extrusion force using | | | 700 | 676 | 713 | 610 | 690 |
| 3 mm nozzle (N) | | | | | | | |
| skin time (min) | | | 45 | 50 | 45 | 45 | 48 |
| gloss at 60° after | | | 14 | 13 | 15 | 28 | 35 |
| 1 d RT | | | | | | | |
| gloss at 60° after | | | 16 | 17 | 16 | 37 | 40 |
| 7 d 60° C. | | | | | | | |
| non-sag after 1 d RT | | | 1 | 1 | 1 | 1 | 1 |
| non-sag after 7 d | | | 1 | 1 | 1 | 1~2 | 1~2 |
| 60° C. | | | | | | | |
| TVOC (μgC/g) | | | 15 | 21 | 15 | 15 | 15 |
| chalking resistance | | | 1 | 1 | 4 | 3 | 3 |
| after 2000 h UVA | | | | | | | |
| chalking resistance | | | 1 | 1 | 4 | 3 | 3 |
| after 2000 h UVB | | | | | | | |

As seen from the above results, the inventive polyurethan composition (E1) exhibits low TVOC while achieving a good and stable matt surface and an excellent chalking resistance after 2000h, as well as good application and mechanical properties.

As seen from the comparation between E1 and E2, the phenyl alkyl sulfonate has achieved a better matt surface stability, compared with the phthalate plasticizer such as DIDP.

As seen from the comparation between E1 and E3-E4, a combination of the MDI-based prepolymer and the TDI-based prepolymer with a combination of diol and triol in each of the prepolymers, has achieved a better chalking resistance, compared with a MDI-based prepolymer alone (E3), and also compared with a triol-based prepolymer alone (E4).

As seen from the comparation between E1 and E5-E8, the phenyl alkyl sulfonate and the acrylic resin (Aronix M8060) should be added in appropriate amounts. Lower or higher amounts would lead to deterioration of some of the properties.

In the context of the present application, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa, e.g., the terms “comprising,” “consisting essentially of,” “consisting of” also include the product of the combinations of elements listed after the term.

1. A polyurethane composition, characterized in that, wherein, it comprises:
a polyurethane prepolymer containing an isocyanate group, comprising:
a MDI-based prepolymer synthesized from a polyether diol and a polyether triol with MDI, and
a TDI-based prepolymer synthesized from a polyether diol and a polyether triol with TDI; and
a phenyl alkyl sulfonate in an amount of 12-25 wt %, based on the total weight of the composition.

2. The polyurethane composition according to claim 1, wherein,
an amount of the MDI-based prepolymer is 25-40 wt %, based on the total weight of the composition; and/or
an amount of the TDI-based prepolymer is 5-10 wt %, based on the total weight of the composition.

3. The polyurethane composition according to claim 1, wherein
the polyether diol is a polyoxyalkylene diol; and/or
the polyether triol is a polyoxyalkylene triol.

4. The polyurethane composition according to claim 1, wherein a mole ratio of the polyether diol to the polyether triol in the polyurethane prepolymer is 1:1.1-1:2.

5. The polyurethane composition according to claim 1, wherein the polyurethane composition further comprises a photocurable material.

6. The polyurethane composition according to claim 5, wherein, the photocurable material is an unsaturated acrylic compound.

7. The polyurethane composition according to claim 1, wherein the polyurethane composition further comprises a photostabilizer.

8. The polyurethane composition according to claim 7, wherein, the photostabilizer is a hindered amine photostabilizer.

9. The polyurethane composition according to claim 1, wherein the polyurethane composition further comprises carbon black.

10. A method for improving matte surface and chalking resistance of a coating of a polyurethane composition, wherein, it comprises adding a phenyl alkyl sulfonate to a polyurethane composition comprising a polyurethane prepolymer containing an isocyanate group prior to curing, wherein,
the polyurethane prepolymer containing an isocyanate group comprises:
a MDI-based prepolymer synthesized from a polyether diol and a polyether triol with MDI, and
a TDI-based prepolymer synthesized from a polyether diol and a polyether triol with TDI; and
the phenyl alkyl sulfonate is added in an amount of 12-25 wt %, based on the total weight of the composition.

11. The method according to claim 10, wherein, further adding a photocurable material to the polyurethane composition.

12. The method according to claim 10, wherein further adding a photostabilizer to the polyurethane composition.

13. The method according to claim 10, wherein the polyurethane composition further comprises carbon black.

14. A method comprising applying the polyurethane composition according to claim 1 as a sealant and/or an adhesive for sealing and/or bonding.
